(19) United States
(12) Patent Application Publication
(10) Pub. No.: US 2004/0219464 A1
(43) Pub. Date: Nov. 4, 2004

(54) Diffractive optical elements formed on plastic surface and method of making

(76) Inventors: Gregory David Dunham, Lake Worth, FL (US); Thomas J. Pack, Boca Raton, FL (US); Ryan Nilsen, Sunrise, FL (US); Frank Garcia, Miami, FL (US)

Correspondence Address: Randi L. Dulaney, Motorola, Inc., Law Department, 8000 West Sunrise Boulevard, Fort Lauderdale, FL, 33322, US

(21) Appl. No.: 10/427,795

(22) Filed: May 1, 2003

(51) Int. Cl. G03C 5/00; B29D 11/00

(52) U.S. Cl. 430/320; 430/321; 264/1.31

(57) ABSTRACT

Negative surface relief diffractive optical elements (218) are supported or formed at interior surfaces of injection molding molds (200, 916, 1002) for wireless communication device housing parts (502). Such injection molding molds are used to making housing parts that include integrally molded surface relief diffractive optical elements (504) e.g., holograms. Such diffractive optical elements can be used to convey information or for decorative effects. The negative surface relief holograms can be mechanically mounted or formed on the interior surfaces by exposing a resist on the interior surfaces to a holographic light field or a succession of laser interference patterns, and there after developing and using the resist as an etch mask.

### BACKGROUND OF THE INVENTION

1. Field of the Invention

The present invention relates in general to wireless communication devices.

2. Description of Related Art

As wireless communication devices have proliferated in the marketplace, the variety of models offered to consumers has greatly increased. As users have grown accustomed to the use of wireless devices, they have begun to regard wireless communication devices as an accessory that aesthetically reflects their tastes, and style. To appeal to younger buyers, there is an interest in making wireless devices more stylish looking, while at the same time preserving affordability.

Holograms have been used to enhance the appearance of wireless devices. For example, transmissive holograms that are placed over wireless telephone displays are available. Such holograms are separately manufactured, contribute to the overall cost of the wireless devices, and have limited visual impact due to the fact that they are transmissive. Reflective holograms are used on wireless devices, for example as proof of authenticity on batteries. Such reflective holograms have limited visual impact due to their small size.

It would be desirable to provide wireless devices that include high visual impact diffractive optics.

### BRIEF DESCRIPTION OF THE FIGURES

The present invention will be described by way of exemplary embodiments, but not limitations, illustrated in the accompanying drawings in which like references denote similar elements, and in which:

FIG. 1 is a flow chart of a method of making a wireless device housing part that includes an integrally molded surface relief hologram;

FIG. 2 is a perspective view of a part of a mold for molding a wireless device housing part that includes an integrally molded surface relief hologram;

FIG. 3 is a cross sectional view of the part of the mold shown in FIG. 2;

FIG. 4 is an insert for supporting a negative surface relief of a hologram in the part of the mold shown in FIGS. 2-3;

FIG. 5 is a front view of a wireless communication device that includes a front housing part including an integrally molded surface relief hologram;

FIG. 6 is a cross sectional view of the wireless communication device shown in FIG. 5;

FIG. 7 is a flow chart of a method of making a negative of a surface relief hologram for use in the mold shown in FIG. 2;

FIG. 8 is a flow chart of a method of forming a negative of a surface relief hologram on an interior surface of an injection molding mold;

FIG. 9 is a schematic of an apparatus for exposing photoresist coated on a surface of an injection molding mold to a succession of laser interference patterns; and

FIG. 10 is a schematic of an apparatus for exposing photoresist coated on a surface of an injection molding mold to a holographic light field.

### DETAILED DESCRIPTION OF THE PREFERRED EMBODIMENTS

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

FIG. 1 is a flow chart of a method 100 of making a wireless device housing part that includes an integrally molded surface relief hologram. A hologram is a type of diffractive optical element that presents an image to a viewer. Referring to FIG. 1, in step 102 a master surface relief hologram is made. The master surface relief hologram is a negative of surface relief holograms that will be made using the master surface relief hologram. The surface relief hologram that will be made using the master hologram can be referred to as a positive surface relief hologram to distinguish from the negative master hologram. In step 104 the master is attached to an injection molding mold insert. In step 106 the insert along with the master is installed in an injection molding mold for a wireless device housing, such that the master faces an interior cavity of the mold. Alternatively, rather than attaching the master to an insert, the master is made sufficiently robust to be secured directly (e.g., via screws), and is secured directly to a part of the mold.

In step 108, a quantity of molten plastic is injected into the injection molding mold in order to form the part of the wireless device housing including a surface relief hologram. As the plastic flows into the mold, the master forms the plastic into a surface relief hologram. In step 110 the molten plastic is allowed to cool and harden, stabilizing the surface relief hologram. In step 112 metal (e.g., aluminum) is deposited over the surface relief hologram. The metal deposited in step 112 is thin enough to conform to undulations of the surface relief hologram without burying those undulations. The metal improves the appearance of the surface relief hologram by increasing the amount of light that is reflected from the surface relief hologram.

The method shown in FIG. 1 provides an efficient, cost effective way to form holograms on complex shaped wireless device housings Such holograms are preferably used to convey information, and for decorative purposes.

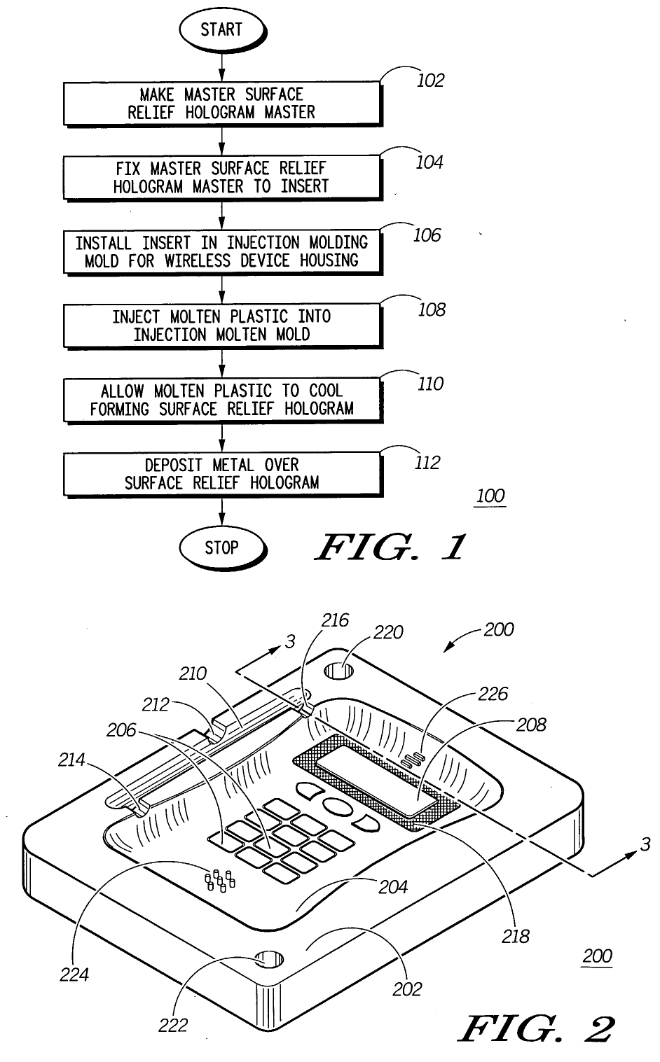

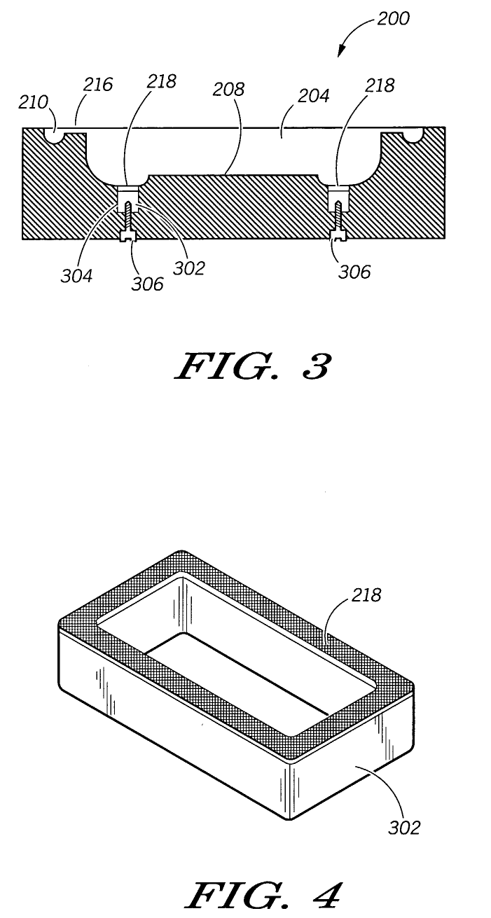

FIG. 2 is a perspective view of a first part of a mold 200 for molding a wireless device housing part that includes an integrally molded surface relief hologram and FIG. 3 is a cross sectional view of the part of the mold shown in FIG. 2. The first part 200 mates with a complimentary second part (not shown). The second part defines that back side of the wireless device housing part and is not of immediate interest. The first part 200 includes a parting surface 202 that contacts a parting surface of the second part of the mold. First 220, and second 222 alignment pin holes are also formed in the parting surface 202. In use the holes 220, 222 accommodate alignment pins that insure the proper registration of the first part 200 with the second part (not shown).

A cavity 204 that determines the shape of an exterior surface of a front part of a housing of a wireless device is formed in the parting surface 202. The second part (not shown) determines the shape of the interior surface of the front part of the housing of the wireless device. A plurality of key hole defining protrusions 206, a plurality of microphone grill defining protrusions 224, a plurality of speaker grill defining protrusions 226 and a display window defining protrusion 208 extends from the bottom of the cavity 204. In use when the first part 200, is assembled with the second part (not shown) the protrusions 206, 224, 226, 208 serve to exclude injected molten plastic from certain regions so as to define openings. Half of a channel 210 for conveying molten plastic through the mold is milled in the parting surface 202. A matching second half is milled in the second part (not shown). An opening 212 for introducing molten plastic from an injection molding machine leads into the channel 210. A first gate 214, and a second gate 216 connect the channel 210 to the cavity 204. In use, molten plastic is introduced through the opening 212, flows through the channel 210, and past the gates 214, 216 into the cavity 204, thereby forming the front part of a housing of a wireless device.

An oval shaped surface relief hologram master 218 is supported on an insert 302 in a congruently shaped oval pocket 304 in the first part of the mold 208. The insert 302 is secured by a plurality of screws 306. The hologram master 218 is preferably secured to the insert 302 by brazing. The hologram master 218 can be brazed to the insert prior to being trimmed down to the oval shape, and subsequently trimmed e.g., with wire electric discharge machining (EDM) machine, a high power laser cutter, or by conventional milling or grinding. The hologram master 218 serves as what is termed a shim in the injection molding art. In use the hologram master 218 serves to define a surface relief hologram in a front housing part made using the first part of the mold 200. FIG. 4 is a perspective view of the insert 302 supporting the hologram master 218.

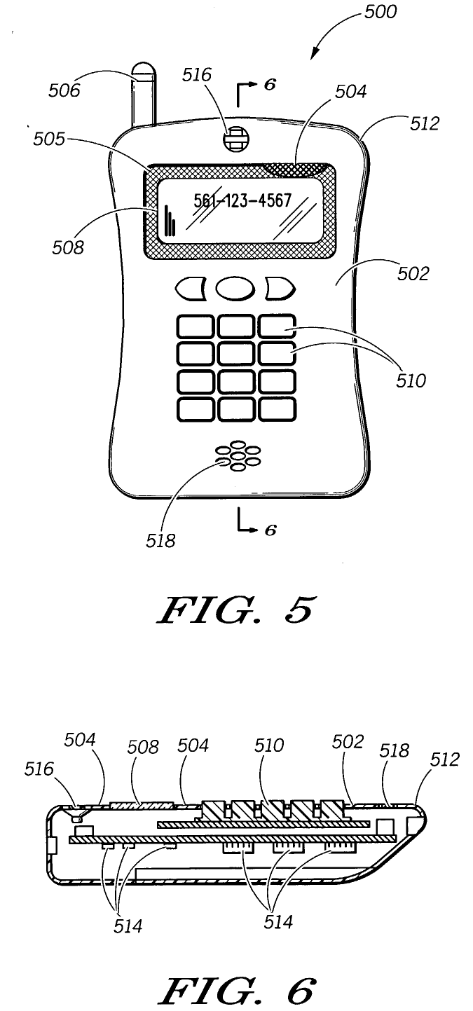

FIG. 5 is a front view of a wireless communication device 500 that includes a front housing part 502 molded using the first part of the mold 200, shown in FIGS. 2-5 and including an integrally molded surface relief hologram 504 formed by the hologram master 218. FIG. 6 is a cross sectional view of the wireless communication device shown in FIG. 5. The wireless communication device 500 comprises, a plurality of electrically interoperating components mechanically coupled together through a housing 512. The components include an antenna 506, a display 508, a plurality of keys 510, and a communication circuit embodied in a plurality of electrical circuit components 514 enclosed in the housing 512. A speaker grill 516, and a microphone grill 518 are located on the front housing part 502.

The surface relief hologram 504 is oval shaped and is located around the display 508. The hologram can be used to convey information, e.g., the name of the network for which the wireless communication device is configured, and also enhance the aesthetic appeal of the wireless communication device 500. The surface relief hologram is preferably covered with a light reflecting thin metal film 505, shown partially cutaway to reveal the underlying integrally molded surface relief hologram 504. The metal film 505 serves to enhance the visibility and durability of the surface relief hologram. The metal film 505 is preferably deposited by sputtering although other metal deposition methods are alternatively used. Alternatively, other types of light reflecting coatings such as chrome inks are used instead of deposited metal. The surface relief hologram 504, being integrally molded in the front housing part 504 enhances the aesthetic appeal of the device 500. Although one particular location and shape of the integrally molded hologram 504 is shown, it is to be understood that shape and location are alternatively varied, and that multiple separate integrally molded holograms are alternatively provided.

According to an alternative embodiment of the invention the front housing part 502 is made from a transparent plastic, the surface relief hologram 504 is formed on an inside surface of the front housing part 502, and the metal film 505 or other light reflecting coating is deposited on the inside surface of the front housing part over the surface relief hologram. In such an alternative embodiment, the surface relief hologram would be visible when viewed through the front housing part 502. To make such a surface relief hologram, the insert 302 would be mounted to the aforementioned second part of the mold (not shown) that mates with the first part of the mold 200 shown in FIG. 2.

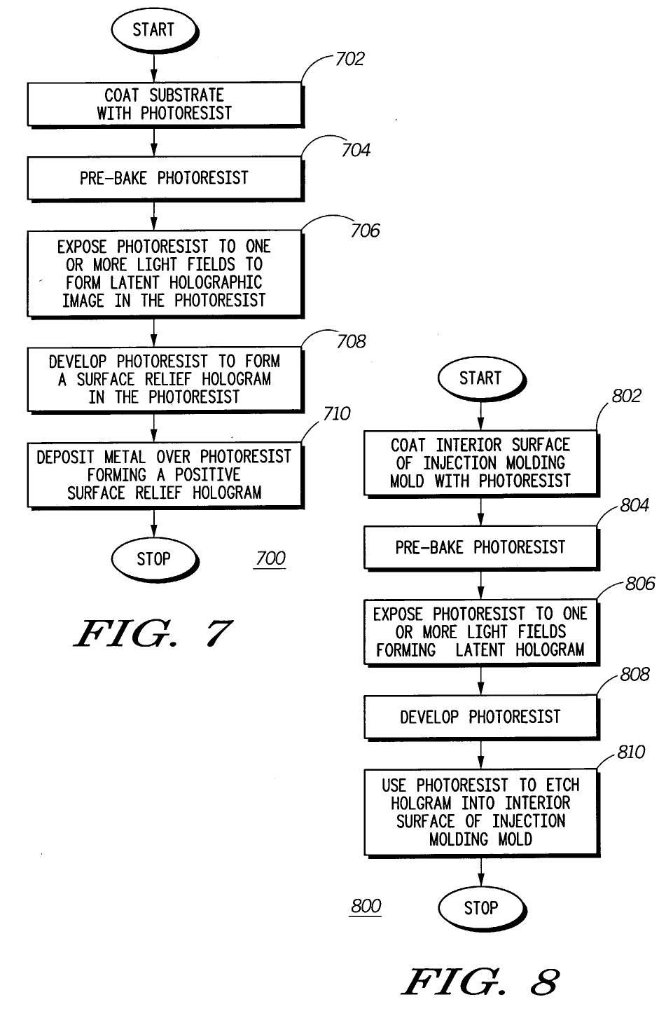

FIG. 7 is a flow chart of a method of making a negative of a surface relief hologram for use in the method shown in FIG. 2, and for use as the hologram master 218 shown in FIGS. 2-4. Referring to FIG. 7, in step 702 a substrate is coated with photoresist. In step 704 the photoresist is pre-baked to drive off volatile solvents. In step 706, the resist is exposed to one or more light fields to form a latent hologram in the photoresist. In step 708 the photoresist is developed to form a surface relief hologram in the photoresist. The developed photoresist includes undulations determined by the intensity distribution of the one or more light fields. The light fields used in step 706 preferably comprises the superposition of a reference phase light field and light scattered from an object.

Alternatively, the light fields used in step 706 comprise multiple spatially and temporally separated interference patterns between two or more coherent laser beams. The interference between two beams generates a latent holographic diffraction grating at the area of impingement of the beams on the photoresist. A holographic representation of a color image can be formed by forming diffraction gratings at each of a plurality of pixel position on the photoresist, where each grating has a pitch selected according to the color of the image to be represented at a point corresponding to the pixel location. The pixel locations are preferably arranged on a compound curve surface, so as to form a holographic representation that wraps around a the compound curve surface.

Optionally, by segregating the pixel locations into a plurality of interleaved sets, and azimuthally orienting the diffractions gratings in each set in a particular direction, a holographic image that changes depending on the azimuthal angle of view can be formed. The latter technique can be used to obtain a variety of visual effects. For example by making each set correspond to a picture of an object from a different perspective, a three dimensional effect can be obtained. Alternatively by making each set correspond to picture of an object in a different state, a morphing effect can be obtained.

Optionally, the developed photoresist is exposed to ultraviolet energy or elevated temperatures in order to strengthen the photoresist. In step 710 metal is deposited over the photoresist forming a negative surface relief master hologram e.g., 218. Step 710 can be carried out by a variety of methods. For example a first relatively thin film of metal can be deposited on the developed photoresist by electroless plating, and thereafter, electroforming can be used to build up the thickness of the master hologram e.g., 218, thereby increasing structural integrity, so as to allow the master hologram e.g., 218 to be able to withstand the stresses involved in handling, mounting on an insert (e.g., 302), and injection molding. The resulting negative surface relief hologram master replicates the undulations formed in the photoresist when the photoresist is developed.

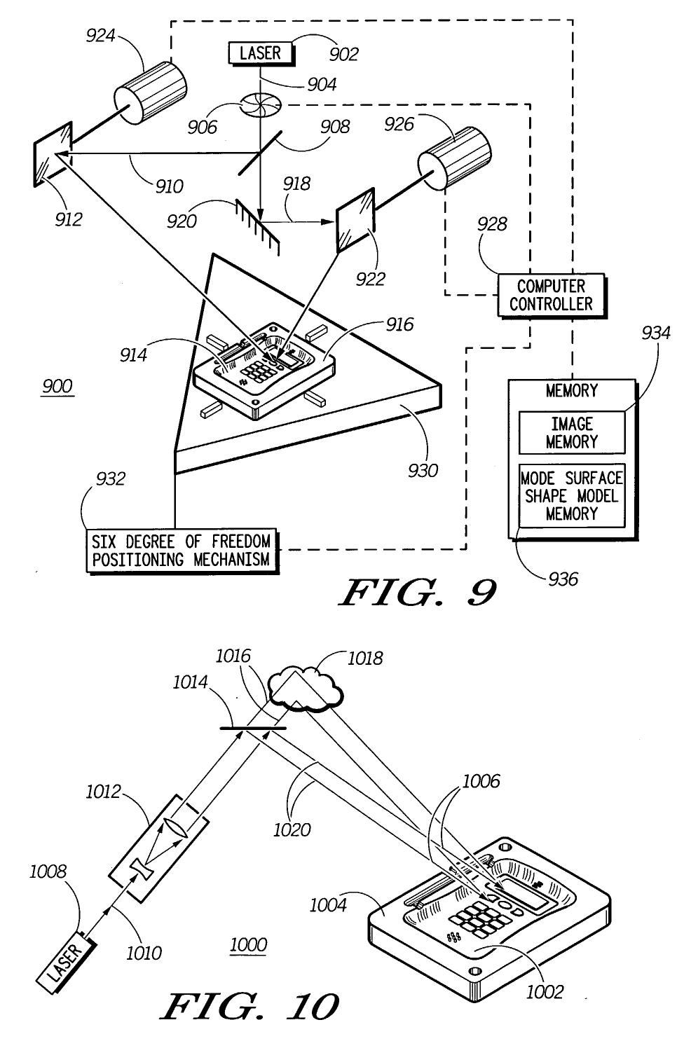

FIG. 8 is a flow chart of a method 800 of forming a negative of a surface relief hologram on an interior surface of an injection molding mold. In step 802 an interior surface of an injection molding mold is coated with photoresist. The coating is preferably accomplished by spraying or electrostatic spraying, and is alternatively coated by another method. In step 804 the photoresist is pre-baked to evaporate volatile solvents. In step 806 the photoresist is exposed to one or more light fields in order to form a latent holographic pattern in the photoresist. In step 808 the photoresist is developed forming a surface relief hologram in the photoresist, and in step 810 the mold is etched using the photoresist to transfer the surface relief hologram to the interior surface of the injection molding mold. The photoresist process is preferably a grayscale lithography process. In a grayscale lithography process, the exposure dose used in step 806, the thickness of the photoresist coated in step 802, and the selectivity of the etchant used in step 810 are selected such that the resist profile resulting after development is sloped and in the course of etching, the resist is etched simultaneously with the underlying mold surface, resulting in grayscale duplication of the surface relief hologram in the surface of the injection molding mold. Alternatively, binary lithography is used. The interior surface of the mold can be plated prior to conducting method 800. Variations of the method shown in FIG. 8 are elaborated in the discussion of FIGS. 9-10 below.\

Alternatively, the resist developed in step 808 is subsequently used to patternwise deposit metal in a metal liftoff deposition process.

FIG. 9 is a schematic of an apparatus 900 for exposing a photoresist coating 914 on an interior surface of an injection molding mold 916 to a succession of laser interference patterns. The apparatus comprises a laser 902 that emits a beam 904 that passes through a shutter 906 and is incident on a partially reflective mirror 908. A first portion of the beam 910 is reflected at the partially reflective mirror 908 toward a first variable orientation turning mirror 912. A second portion of the beam 918 is transmitted through the partially reflective mirror 908, and is reflected by a fixed turning mirror 920 toward a second variable orientation turning mirror 922. The first and second variable orientation turning mirrors 912, 922 are oriented by first 924, and second 926 servo motors respectively. Portions of the beam 910, 918 reflected by the first and second variable orientation turning mirrors 912, 922 intersect at the surface of the mold 916.

An interference pattern created at the intersection of the two portions 910, 918 of the beam 904 on the photoresist 914 generates a localized (substantially limited to a pixel area) diffraction grating pattern. The pitch of the diffraction grating pattern is determined by the angle between the intersecting portions 910, 918 of the beam 904. The angles between the portions 910, 918 of the beam 904 are adjusted to generate diffraction grating patterns in the photoresist 914 that have different pitches or spatial frequencies so that different colors of light (e.g., red, blue and green) can be diffracted in the same general direction i.e., a viewing direction corresponding to a particular diffraction order of the diffraction gratings patterns. For each pixel area of the photoresist 914, servo motors 924, 926, and the shutter 906 are operated by a computer controller 928 in response to color image information stored in an image memory 934. According to one methodology for each pixel, and for each of three primary color amplitudes for each pixel, the servo motors 924, 926 are operated to set the portions 910, 918 of the beam 904 to intersect at an angle, such that a latent diffraction grating pattern generated by the intersecting beam portions 910, 912 has a spatial frequency component that (when ultimately made into a diffraction grating for the pixel) diffracts light corresponding to the primary color in a viewing direction. According to this methodology, for each primary color the shutter is opened for a duration determined by the amplitude of the primary color in the pixel (in the color image information), to obtain a commensurate amplitude of the corresponding spatial frequency component. Alternatively, intensity modulation of the laser is used to control the amplitude of spatial frequency components of the diffraction grating. Alternatively, separate pixels are dedicated to separate primary colors, such that the diffraction grating formed in each pixel area has a single spatial frequency component. Alternatively, the beam portions 910, 918 are set to intersect at angles to produce diffraction gratings that diffract other colors aside from three primary colors in the viewing direction.

Each spatial frequency component gives rise to diffraction of one color or wavelength (e.g., red, blue, or green) in at least one direction (e.g., a viewing direction corresponding to a diffractions order). The relative amplitude of each spatial frequency component is determined by the duration for which the portions 910, 918 of the beam 904 intersecting at a particular angle of intersection of that yields the spatial frequency component irradiate the photoresist, or alternatively the power of the beam 904. The relative amplitude of each spatial frequency component in turn controls the intensity of light of a corresponding wavelength or color that is concentrated into diffraction orders by gratings corresponding to the grating pattern. Thus, the color and brightness of each pixel area when viewed from particular directions is controlled. The color and brightness of each pixel area is controlled according to image information stored in an image memory 934 accessed by the controller computer 928. Alternatively, each pixel area includes a diffraction grating pattern having a single spatial frequency component produced by exposing the pixel area to a single interference pattern (corresponding to an angle of intersection) of the two of portions 910, 918 of the beam, for a duration dictated by the color image information. Pixel areas can be segregated into a plurality of interleaved sets, each of which is assigned a particular azimuthal grating orientation to obtain a variety of visual effects as described above in connection with FIG. 7.

The coherence length of the laser 902 is preferably greater than the maximum difference in the path lengths for the two portions 910, 918 of the beam 904. If a laser that has a limited coherence length is to be used, the optical paths can be rearranged e.g., by a different arrangement of turning mirrors to meet the foregoing condition.

The injection molding mold 916 is supported on a stage 930, that is mechanically driven by a six degrees of freedom positioning mechanism 932. The six degrees of freedom positioning mechanism 932 allows for control of position (e.g., X, Y, Z coordinates), and orientation (e.g., roll, pitch, and yaw) to be controlled. The six degrees of freedom positioning mechanism 932 is used to bring successive pixel areas of the photoresist 914 to the point of convergence of the portions 910, 918 of the beam 904. The six degree of freedom position mechanism 932 allows pixels to be evenly spaced along the compound curve surface of the mold, as opposed to be evenly spaced in a Cartesian plane. The six degrees of freedom positioning mechanism 932 also allows a local surface normal to the interior surface of the mold 916 to be oriented within a plane that includes the interfering portions 910, 918 of the beam 904, or otherwise as desired. The six degrees of freedom positioning mechanism 932 preferably comprises a robotic manipulator. Alternatively, the six degrees of freedom positioning mechanism 932 comprises a Stewart platform. The six degrees of freedom positioning mechanism 932 is driven by the computer controller 928. A computer model (e.g., a bicubic spline model) of the surface of the mold 916 is stored in a mold surface shape model memory 936 and, and the computer controller 928 preferably drives the six degrees of freedom positioning mechanism 930 on the basis of the computer model in order to position and orient successive pixel areas as previously described. Three position degrees of freedom are used to position successive points (pixels) of the mold 916 surface which is preferably a compound curve (3-space) surface. Two orientation degrees of freedom are used to orient the compound curve surface relative to the incident portions of the laser beam 904, and a final orientation degree of freedom is preferably used to azimuthally orient the mold 916 so that the orientation of the holographic diffraction gratings formed in the resist 914 can be selected for the purposes described above.

According to one mode of operation, the variable orientation turning mirrors 912, 922 are operated to set the angle of intersection of the beam portions 910, 918 to produce a latent diffraction grating pattern corresponding to a first color for a first pixel area. Thereafter the positioning mechanism 930 is operated to bring each successive pixel areas to the point of intersection of the portions of the beam 904, and to orient the mold 916 as previously described. As each pixel area is brought into position and oriented, the angle between the beam portions 910, 918 is optionally adjusted to compensate for the orientation of the mold surface at the pixel, relative to the viewing angle. When each pixel area is brought into position and oriented, the shutter 906 is operated for a time determined by pixel color information stored in the controller computer. The process is then repeated for each remaining primary color. If the pixels are to be segregated into a plurality of sets having different grating azimuth orientation, the different azimuth orientations are preferably handled in separate passes to limit the need to rotate the mold 916 for successive pixels. After every pixel area that is to be exposed has been fully exposed, the photoresist 914 is processed, and thereafter used as an etch mask for transferring the diffraction grating patterns formed in the photoresist 914 into the injection molding mold 916. The photoresist is preferably processed using grayscale lithography techniques as described above. Subsequently the injection molding mold 916 is used to mold parts (e.g., wireless device housing parts) that have integrally molded surface relief holograms. Optionally, the surface relief holograms on the molded parts are metallized to enhance their visibility.

The apparatus 900 shown in FIG. 9 allows master surface relief holograms to be formed on complex shaped molds, and in turn allows surface relief holograms to be formed on complex shaped parts, e.g., parts that include compound curves, and abrupt steps.

According to an alternative embodiment of the invention, the apparatus shown in FIG. 9 is used to exposed photoresist on a part e.g., a machined part that has a shape that is the negative of the injection molding mold 916, the photoresist is then developed, and the negative of the injection molding mold along with the developed photoresist is used as a substrate to electroform at least a part of the injection molding mold 916. Such an alternative avoids the step of grayscale lithography.

FIG. 10 is a schematic of an apparatus 1000 for exposing a photoresist 1002 coated on a surface of an injection molding mold 1004 to a holographic light field 1006. The apparatus 1000 includes a laser source 1008. A beam 1010 emitted by the laser 1008 is expanded by a beam expander 1012, and thereafter incident on a partially reflecting mirror 1014. A first portion 1016 of the beam 1010 is transmitted through the mirror 1014, is incident on an object 1018, and is scattered by the object toward the photoresist 1002. A second portion 1020 of the beam 1010 is reflected by the mirror 1014 toward the photoresist 1002. The first 1016, and second 1020 portions of the beam interfere forming the holographic light field 1006 that exposes the photoresist 1002, thereby forming a latent hologram in the photoresist 1002. The photoresist 1002 is subsequently developed to form a hologram pattern in the photoresist 1002, and is then used as an etch mask to transfer the hologram pattern to the surface of the mold 1004. The mold 1004 is then used to form plastic parts, e.g., wireless device housing parts that include surface relief holograms. The surface relief holograms are optionally metallized to improve their visibility. The apparatus shown in FIG. 10, and the method described above in connection with FIG. 10 provides an alternative to the method shown in FIG. 9, and the method described in the context of FIG. 9 for forming a hologram on an interior surface of an injection molding mold, and using the mold to make an injection molded part that includes an integrally molded surface relief hologram.

As used in the present description, the term housing part includes removable housing parts such as removable front covers.

While the preferred and other embodiments of the invention have been illustrated and described, it will be clear that the invention is not so limited. Numerous modifications, changes, variations, substitutions, and equivalents will occur to those of ordinary skill in the art without departing from the spirit and scope of the present invention as defined by the following claims.

What is claimed is:

1. An injection molded part comprising a surface relief diffractive optical element.

2. The injection molded part according to claim 1, wherein the surface relief diffractive optical element comprises a hologram.

3. An injection molding mold comprising:
a mold cavity comprising a surface; and
a negative surface relief pattern of a diffractive optical element located at the surface.

4. The injection molding mold according to claim 3 wherein:
the negative surface relief pattern of the diffractive optical element is formed on a shim that is supported at the surface.

5. The injection molding mold according to claim 3 wherein:
the negative surface relief pattern of the diffractive optical element is formed in the surface.

6. The injection molding mold according to claim 5 wherein:
the negative surface relief pattern is etched into the surface.

7. A method of making a surface relief diffractive optical element comprising:
injecting molten plastic into an injection molding mold that includes a negative surface relief diffractive optical element; and
allowing the molten plastic to cool to form a plastic part comprising a positive surface relief diffractive optical element.

8. The method of making a surface relief diffractive optical element according to claim 7 further comprising:
depositing metal over the positive surface relief optical element.

9. The method of making a surface relief diffractive optical element according to claim 7 further comprising:
making the negative surface relief diffractive optical element; and
mounting the negative surface relief diffractive optical element at an interior surface of the mold, prior to injecting molten plastic into the injection molding mold.

10. The method of making a surface relief diffractive optical element according to claim 9 wherein:
making the negative surface relief diffractive optical element comprises:
coating a substrate with photoresist;
exposing the photoresist to light to form a latent diffractive optical element pattern in the photoresist;
developing the photoresist to form a positive surface relief diffractive optical element in the photoresist;
depositing metal on the positive surface relief diffractive optical element in the photoresist, forming the negative surface relief diffractive optical element.

11. The method according to claim 10 further comprising:
machining the substrate to a compound curve that is a negative of at least a portion of the mold shape; and
wherein depositing metal comprises:
electroforming the negative surface relief diffractive optical element.

12. The method according to claim 11 further wherein exposing the photoresist comprises:
positioning the substrate on a stage that has, at least, position degrees of freedom;
for each of a plurality of pixel areas on the compound curve surface of the substrate:
actuating the stage to position each pixel area at a point of intersection of at least two coherent laser beams; and
selecting an angle of intersection of the at least two coherent laser beams, and irradiating each pixel area with an interference pattern of the at least two coherent laser beams according to color image information.

13. The method according to claim 7 further comprising:
forming the negative surface relief diffractive optical element on an interior surface of the injection molding mold.

14. The method of making a diffractive optical element according to claim 13 further comprising:
depositing metal on the positive surface relief diffractive optical element.

15. The method of making a diffractive optical element according to claim 13 wherein:
forming the negative surface relief diffractive optical element on the interior surface of the mold comprises:
coating a compound surface of the mold with photoresist;
for each of a plurality of pixel areas on the compound curve surface of the mold:
irradiating each pixel area with an interference pattern of two coherent laser beams according to image information;
developing the photoresist; and
etching the compound curve mold surface using the photoresist as an etch mask.

16. The method of making a diffractive optical element according to claim 13 wherein:
forming the negative surface relief diffractive optical element on the interior surface of the mold comprises:
coating a compound surface of the mold with photoresist;
positioning the mold on a stage that has position, and orientation degrees of freedom;
for each of a plurality of pixel areas on the compound curve surface of the mold:
actuating the stage to position each pixel area at a point of intersection of at least two coherent laser beams, and orienting the compound surface relative to the coherent beams; and
selecting an angle of intersection of the at least two coherent laser beams, and irradiating each pixel area with an interference pattern of the at least two coherent laser beams according to color image information;
developing the photoresist; and
etching the compound curve mold surface using the photoresist as an etch mask.

17. The method of making a diffractive optical element according to claim 13 wherein:
forming the negative surface relief diffractive optical element on the interior surface of the mold comprises:
coating a surface of the mold with a photoresist;
exposing the photoresist to a holographic light field;
developing the photoresist; and
etching the mold surface using the photoresist as an etch mask.

18. A method of making a plastic housing part that is decorated with a hologram, the method comprising:
making a negative surface relief pattern of a hologram;
placing the negative surface relief pattern of the hologram on an interior surface of an injection molding mold for the plastic housing part;
injecting molten plastic into the injection molding mold.

19. A method of making a plastic housing part that is decorated with a hologram, the method comprising:
making a negative surface relief pattern of a hologram on an interior surface of a mold for the housing part; and
injecting molten plastic into the mold of the housing part.

20. A communication device comprising:
a housing comprising a plastic housing part comprising a surface relief hologram molded in the plastic housing part; and
a communication circuit enclosed in the housing.

21. The communication device according to claim 20 further comprising:
a metal film deposited over the surface relief hologram.
